(19) United States
(12) Patent Application Publication
(10) Pub. No.: US 2025/0120406 A1
(43) Pub. Date: Apr. 17, 2025

(54) Method for preparing a foodstuff dough

(71) Applicant: Sancassiano S.p.A., Roddi Cuneo (IT)

(72) Inventor: Davide DROCCO, Roddi Cuneo (IT)

(21) Appl. No.: 18/913,209

(22) Filed: Oct. 11, 2024

(30) Foreign Application Priority Data
Oct. 13, 2023 (IT) 102023000021384

(51) Int. Cl. A21C 1/14; A21C 1/02

(52) U.S. Cl. CPC A21C 1/1495; A21C 1/02

(57) ABSTRACT

Described herein is a method for preparing a foodstuff dough, including a dough for oven-baked products, including the steps of providing a tank for preparation of the dough; introducing into a cavity of the tank ingredients for preparation of the dough; I positioning the tank in a heat-conditioning station that includes a source for supplying a heat-conditioning fluid, and via a connection system, setting in fluid communication a chamber of the tank and the supply source; in the condition of fluid communication between the chamber and the supply source, carrying out a step of heat conditioning of the ingredients introduced into the cavity, wherein the heat-conditioning fluid is supplied by the supply source and made to circulate through the chamber; and removing the tank from the heat-conditioning station and transferring the tank to a further operating station.

The present invention relates to a method for preparing a foodstuff dough, preferably a dough for oven-baked products.

It is known in the art to prepare a foodstuff dough in pre-set thermal conditions with the aid of heat-conditioning means having the function of keeping the ingredients being processed within a pre-set temperature range.

In particular, it is known to use a tank for preparation of doughs that comprises a cavity for gathering ingredients, and a heat-conditioning chamber set in a heat-exchange relationship with one or more walls that delimit the aforesaid cavity.

Moreover, it is known to use an apparatus for preparing foodstuff doughs that comprises one or more kneading tools for carrying out a step of preparation of the dough on the ingredients contained in the tank, and further comprising a source for supplying a heat-conditioning fluid that is set in communication with the heat-conditioning chamber of the tank and supplies the heat-conditioning fluid to the heat-conditioning chamber of the tank so as to cool down or heat the walls of the tank and consequently keep the ingredients being processed in the pre-set temperature range.

In this context, the present applicant has provided an improved solution that makes it possible to carry out more effective heat conditioning of the ingredients, carry out faster production cycles, and be more versatile in adapting to the needs of the specific applications.

In general, the solution described herein regards a method according to claim 1, and a system according to claim 7.

The claims form an integral part of the teaching provided herein.

Further characteristics and advantages of the present invention will emerge clearly from the ensuing description with reference to the annexed drawings, which are provided purely by way of non-limiting example and in which:

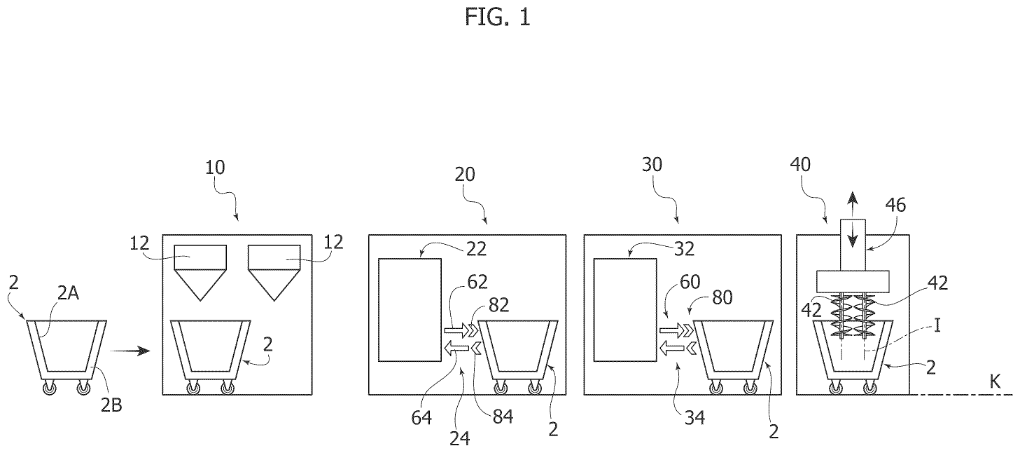

FIG. 1 is a schematic illustration of an example of the method and the system described herein.

In the ensuing description, various specific details are illustrated aimed at enabling an in-depth understanding of the embodiments. The embodiments may be provided without one or more of the specific details, or with other methods, components, or materials, etc. In other cases, known structures, materials, or operations are not illustrated or described in detail so that various aspects of the embodiment will not be obscured.

The references used herein are provided merely for convenience and hence do not define the sphere of protection or the scope of the embodiments.

As anticipated above, the solution described herein regards the preparation of foodstuff doughs, preferably doughs for oven-baked products.

In general, the solution described herein relates to a method comprising the steps of:
providing a tank for preparation of the dough,
wherein the tank comprises a cavity for gathering ingredients, and a heat-conditioning chamber set in a heat-exchange relationship with one or more walls that delimit the gathering cavity of the tank;
introducing into the tank one or more ingredients for preparation of the dough;
positioning the tank in a heat-conditioning station comprising a source for supplying a heat-conditioning fluid, and via a connection system setting in fluid communication the chamber of the tank and the supply source of the heat-conditioning station;
in the aforesaid condition of fluid communication between the chamber of the tank and the supply source of the heat-conditioning station, carrying out a step of heat conditioning of the ingredients gathered together in the cavity of the tank, wherein a heat-conditioning fluid is supplied by the supply source and made to circulate through the chamber of the tank; and
removing the tank from the heat-conditioning station and transferring it to a subsequent operating station.

The step of introduction of the ingredients into the tank can be carried out before or after positioning of the tank in the heat-conditioning station.

Preferably, the tank containing the ingredients on which the heat-conditioning step has been carried out is subsequently transferred to a station for preparation of the dough, which comprises a kneading unit equipped with at least one kneading tool; the tank is positioned within the station for preparation of the dough and, via the at least one kneading tool of the station, a step of preparation of the dough is carried out on the ingredients contained in the tank.

In one or more preferred embodiments, the method moreover envisages the use of at least one further tank for preparation of the dough, where the at least one further tank comprises a cavity for receiving ingredients and a heat-conditioning chamber set in a heat-exchange relationship with one or more walls that delimit the cavity of the tank.

In one or more preferred embodiments, the method includes the further steps of:
introducing into the at least one further tank one or more ingredients for preparation of the dough;
positioning the at least one further tank in the heat-conditioning station; and
carrying out a step of heat conditioning of the ingredients gathered together in the at least one further tank, where a heat-conditioning fluid is supplied by the supply source and made to circulate through the chamber of the at least one further tank. Preferably, the heat-conditioning step carried out in the heat-conditioning station on the ingredients contained in the at least one further tank is performed simultaneously with the step of preparation of the dough that carried out in the station for preparation of the dough on the ingredients contained in the first tank.

Preferably, the heat-conditioning step and the step of preparation of the dough are carried out on the basis of one and the same cycle time.

In view of the foregoing, the solution described herein hence envisages carrying out the step of heat conditioning of the ingredients in an operating station distinct from the station for preparation of the dough.

Thanks to the above characteristic, the step of heat conditioning of the ingredients can be carried out in a way independent of the step of preparation of the dough and hence does not need to be constrained to the operating requirements of the station for preparation of the dough, such as the duration of the kneading operation or else the need to subject the tank to a motion of rotation during the kneading operation.

Consequently, the heat-conditioning step can be carried out during the same cycle time as that in which in the station for preparation of the dough preparation of the dough is carried out in a further tank.

In this way, the time necessary for carrying out the heat-conditioning step can be “masked” by the cycle time of the step of preparation of the dough.

Moreover, if the time necessary for carrying out the heat-conditioning step exceeds the cycle time of the step of preparation of the dough, it is possible to envisage two or more heat-conditioning stations so as to divide the heat-conditioning step into a number of sessions or sub steps, each defined by a duration shorter than or equal to the cycle time of the step of preparation of the dough.

On the other hand, the solution described herein bestows ample freedom in developing a specific method for a given application, thanks precisely to the fact of having separated into two distinct stations the heat-conditioning step and the step of preparation of the dough.

For instance, after the heat-conditioning step, the method may envisage introduction of further ingredients into the tank and, possibly, execution of a second heat-conditioning step.

Once again by way of example, after the ingredients have been subjected to the step of preparation of the dough, the method may envisage carrying out a further heat-conditioning step, and possibly repeating the step of preparation of the dough.

As may be understood, the possibilities of configuration of the method are numerous, which renders the solution described herein very versatile.

With reference now to FIG. 1, this is a schematic illustration of an example of implementation of the solution described herein.

In one or more preferred embodiments like the one illustrated, the method-and likewise the system described herein-comprises the use of a plurality of tanks 2 that are mobile for being positioned in the various operating stations provided.

Each tank 2 comprises a cavity 2A for gathering ingredients, and a heat-conditioning chamber 2B; for the cavity 2A and the heat-conditioning chamber 2B the teachings already presented above apply.

In the example illustrated, the tanks 2 are mobile on wheels; in any case, the mobility of the tanks 2 may be obtained also via means of some other type, for example, through mobile platforms capable of lifting the tanks and displacing them between the various operating stations.

In one or more preferred embodiments like the one illustrated, the system comprises, in succession along a processing path K, a first station 10 for introduction of the ingredients into the tanks 2, a first heat-conditioning station 20, a second heat-conditioning station 30, and finally a station for preparation of the dough 40.

In one or more preferred embodiments, the system comprises a conveyor system for feeding the individual tanks 2 along the processing path K and taking them to the various operating stations.

The station 10 may, for example, comprise a plurality of hoppers 12 containing different ingredients, which, in an automatic or semi-automatic way (by “semi-automatic way” is meant an operating mode in which one or more control or working operations are carried out by an operator), introduce the ingredients necessary for preparation of the dough into each tank 2 that positions itself within the station 30.

The first heat-conditioning station 20 and the second heat-conditioning station 30 comprise respective supply sources 22, 32, for supply of a heat-conditioning fluid, and respective connection systems 24, 34, configured for setting in fluid communication the supply sources 22, 32 with the heat-conditioning chambers 2B of the tanks 2 that are positioned in the stations.

The heat-conditioning stations 20, 30 may be configured for operating in an automatic or else semi-automatic way.

In one or more preferred embodiments, the connection system 24/34 of one or both of the two heat-conditioning stations 20, 30 comprises a connection unit 60, preferably of a fast-coupling type, which is configured for connecting up to a connection unit 80 provided on each of the tanks 2 and is set in fluid communication with the heat-conditioning chamber 2B of the respective tank.

In one or more preferred embodiments, the connection unit 60 of the heat-conditioning station 20/30 comprises a delivery coupling 62 and a return coupling 64.

In one or more preferred embodiments, the connection unit 80 of each tank 2 comprises an inlet coupling 82 and an outlet coupling 84 that are to couple, respectively, with the delivery coupling 62 and the return coupling 64 of the connection unit 60 of the heat-conditioning station.

In one or more preferred embodiments, in the heat-conditioning station 20/30 the source for supplying the heat-conditioning fluid 22/32 and the chamber 2B of the tank 2 are set in mutual communication so as to create a closed circuit for circulation of the heat-conditioning fluid so that, during the step of heat conditioning of the ingredients, the heat-conditioning fluid can circulate in a continuous way through the chamber 2B of the tank 2.

The station 40 for preparation of the dough comprises a pair of tools 42, which are rotatable about respective axes of rotation I and are configured for carrying out an action of kneading on the ingredients contained in each tank 2 that is positioned within the station.

In one or more preferred embodiments, the station 40 moreover comprises a system 46 for moving the two kneading tools 42 so as to insert them into the tank 2 that comes to position itself in the station for subjecting the ingredients contained therein to the kneading operation and to take them out of the tank at the end of the above operation. Alternatively, the station 40 may comprise a system for moving the tank 2 for the same purpose.

In one or more preferred embodiments, the station 40 may moreover be configured with means for driving a movement of rotation of the tank 2 itself simultaneously with the kneading operation carried out by the two kneading tools 42.

As for the previous stations, the station 40 for preparation of the dough may be configured for automatic or else semi-automatic operation.

In some applications, the method described herein may envisage that, after the heat-conditioning step carried out in the station 20 or 30, the tank 2 is brought back into the station 10 for introduction of further ingredients and, subsequently, positions itself again in the station 20 or 30 for execution of a further step of heat conditioning of the ingredients or else positions itself directly in the station 40 for preparation of the dough.

Moreover, in some applications, after the step of preparation of the dough carried out within the station 40, the tank 2 may return into the station 20 or 30 for execution of a further heat-conditioning step.

Of course, without prejudice to the principle of the invention, the details of construction and the embodiments may vary, even significantly, with respect to what is illustrated herein purely by way of non-limiting example, without thereby departing from the scope of the invention, as defined by the annexed claims.

1. A method for preparing a foodstuff dough, including a dough for oven-baked products, comprising the steps of:
providing a tank for preparation of said dough, wherein said tank comprises a cavity for gathering ingredients, and a heat-conditioning chamber set in a heat-exchange relationship with one or more walls that delimit said cavity;
introducing into said cavity of said tank one or more ingredients for preparation of said dough;
positioning said tank in a heat-conditioning station that comprises a supply source for supplying a heat-conditioning fluid, and via a connection system, setting in fluid communication said chamber of said tank and said supply source of said heat-conditioning station;
wherein the step of introducing the one or more ingredients into said cavity of said tank is configured to be performed before or after the step of positioning said tank in said heat-conditioning station,
in said fluid communication between said chamber of said tank and said supply source of said heat-conditioning station, carrying out a step of heat-conditioning of said one or more ingredients introduced into the cavity of said tank, wherein the heat-conditioning fluid is supplied by said supply source and made to circulate through said chamber of said tank; and
removing said tank from said heat-conditioning station and transferring said tank to a further operating station.

2. The method according to claim 1, comprising, after said step of heat-conditioning of said one or more ingredients, the steps of:
removing said tank from said heat-conditioning station and transferring said tank to the further operating station for preparation of the dough, wherein said further operating station for preparation of the dough comprises a kneading unit equipped with at least one kneading tool; and
positioning said tank in said further operating station for preparation of the dough and, via said at least one kneading tool, carrying out a step of preparation of the dough on the one or more ingredients contained in said cavity of said tank.

3. The method according to claim 1, comprising at least one further step of heat conditioning of said one or more ingredients introduced into the cavity of said tank, which is carried out in said heat-conditioning station or else in a second heat-conditioning station, before or after said step of preparation of the dough.

4. The method according to claim 2, wherein said step of preparation of the dough includes driving said at least one kneading tool according to a movement of kneading and simultaneously moving said tank according to a movement of rotation about a vertical axis of rotation.

5. The method according to claim 2, wherein said step of preparation of the dough includes driving said at least one kneading tool according to a movement of kneading and simultaneously keeping said tank fixed.

6. The method according to claim 1, wherein the step of introduction of the one or more ingredients is carried out in said heat-conditioning station or else in a further station distinct therefrom.

7. The method according to claim 1, comprising at least one further tank for preparation of said dough,
wherein said at least one further tank comprises a further cavity for gathering ingredients, and a heat-conditioning chamber set in a heat-exchange relationship with one or more walls that delimit said further cavity;
wherein said method includes:
introducing into said further cavity of said at least one further tank one or more ingredients for preparation of said dough;
positioning said at least one further tank in said heat-conditioning station; and
carrying out a step of heat conditioning of said one or more ingredients introduced into the further cavity of said at least one further tank, wherein the heat-conditioning fluid is supplied by said supply source and made to circulate through said chamber of said at least one further tank,
wherein said heat-conditioning step carried out in said heat-conditioning station on the one or more ingredients contained in said at least one further tank is performed simultaneously with said step of preparation of the dough carried out in said further operating station for preparation of the dough on the one or more ingredients contained in said tank.

8. The method according to claim 7, wherein said heat-conditioning step and said step of preparation of the dough are carried out on a basis of one and the same cycle time.

9. A system for implementation of the method for preparing the dough according to claim 1, comprising:
the tank, comprising the cavity for gathering ingredients, and the heat-conditioning chamber set in the heat-exchange relationship with the one or more walls that delimit said cavity;
the heat-conditioning station comprising the supply source for supplying the heat-conditioning fluid and the connection system configured to set in fluid communication said supply source and the chamber of the tank that positions itself in said heat-conditioning station; and
a further station for preparation of the dough, comprising at least one kneading tool,
wherein said tank is mobile for being transferred from said at least one heat-conditioning station to said further station for preparation of the dough.

10. The system according to claim 9, wherein said tank is rotatable about a vertical axis of rotation, or else is fixed in a manner that it does not have a possibility of rotating about an axis of rotation.

11. The system according to claim 9, comprising a plurality of tanks and a conveyor system for carrying one tank after another of the plurality of tanks to said at least one heat-conditioning station and to said further station for preparation of the dough.

12. The system according to claim 9, wherein via the connection system, the supply source for supplying the heat-conditioning fluid and the chamber of the tank are configured to be set in mutual communication so as to create a closed circuit for circulation of the heat-conditioning fluid so that, during the step of heat conditioning of the ingredients, the heat-conditioning fluid is configured to circulate in a continuous way through the chamber of the tank.

13. The system according to claim 9, wherein said connection system comprises a first connection unit that is in fluid communication with said supply source, and wherein said tank comprises a second connection unit that is in fluid communication with said chamber of said tank, and wherein said first and second connection units are configured to be releasably coupled so as to set in fluid communication said supply source of said heat-conditioning station and said chamber of said tank, when said tank is positioned in said heat-conditioning station.

14. The system according to claim 13, wherein said first connection unit of the heat-conditioning station comprises a delivery coupling and a return coupling, and said second connection unit of said at least one tank comprises an inlet coupling and an outlet coupling that are configured to couple, respectively, with said delivery coupling and said return coupling of said first connection unit of the heat-conditioning station.

15. The system according to claim 9, comprising another station for introduction of the ingredients into said cavity of said tank.

16. The system according to claim 9, comprising a second heat-conditioning station, which comprises a second supply source for supplying the heat-conditioning fluid and the connection system configured to set in fluid communication said second supply source and the chamber of the tank that positions itself in said second heat-conditioning station.
